(19) United States
(12) Patent Application Publication
(10) Pub. No.: US 2006/0247130 A1
(43) Pub. Date: Nov. 2, 2006

(54) Compositions comprising lignosulfonates for crop protection and crop improvement

(76) Inventors: Wilhelmus Maria Van Der Krieken, Wageningen (NL); Cornelis Johannes Kok, Nijmegen (NL); Lucas Henricus Stevens, Utrecht (NL)

Correspondence Address: Christine A Lekutis;Medlen & Carroll, Suite 350, 101 Howard Street, San Francisco, CA, 94105, US

(21) Appl. No.: 10/543,702

(22) PCT Filed: Jan. 27, 2004
(86) PCT No.: PCT/EP04/00742

§ 371 Date: Apr. 17, 2006

(30) Foreign Application Priority Data
Jan. 27, 2003 (WO) PCT/EP03/00840

(51) Int. Cl. A01N 43/02; A01N 37/18; A01N 25/00

(52) U.S. Cl. 504/291; 504/334; 504/358

(57) ABSTRACT

The invention relates to a composition for protecting an agricultural crop against external threats, such as weeds, pathogens, abiotic and biotic stresses and/or for improving the quality of the products produced by the crop, which composition comprises one or more poly-phenols and one or more other active ingredients. The other active ingredients may be natural crop protection compounds, metals, acids, all three optionally combined with each other and/or chemical. antimicrobial agents, or may be small particles of organic material, in particular of fibrous organic material, compounds that induce stress tolerance, compounds that stimulate wound repair and growth, or cellulose containing materials.

The present invention relates to compositions for protecting crops, such as cereals like wheat, corn etc., and flowers, fruits etc. against external threats, in particular against pathogens, such as fungi, for improving yield and/or quality, to methods using these compositions and to plants or plant parts treated with the composition.

Agricultural crops are often subjected to a variety of biotic and abiotic threats, that can be induced by pathogens, weeds, temperature, drought, light etc. These stress factors can affect the yield and/or quality of the product. In addition, it is generally appreciated by consumers to buy produce of high quality without stress symptoms, such as leaf yellowing, wilting or chlorosis.

Plants are threatened by various pathogenic micro-organisms like fungi, viruses and bacteria. To overcome the problem of infections with these micro-organisms, large quantities of anti-microbial compounds (in particular synthetic pesticides, such as fungicides and bactericides) are applied. From an environmental and health point of view it is desirable to reduce the amount of chemicals that are applied to the plants and the soil.

It is known that certain compounds of natural origin can protect the plant against pathogenic micro-organisms. These so-called natural crop protection compounds (NCP's) are organic substances derived from natural organisms (e.g. pheromones, plant extracts), or anorganic compounds found in the natural environment (e.g. phosphates, sulfur). Thus, in contrast to NCP's, conventional pesticides are synthetic chemicals specifically designed for plant protection. The use of these natural crop protection compounds (NCP's) is becoming more and more preferable since governments world-wide aim for a reduction in the use of synthetic anti-microbial compounds.

However, these NCP's have limited usefulness, because they generally exhibit only modest activity. When used at high concentrations they often have phytotoxic effects. In addition, the action of NCP's appears to be rather unpredictable (depending on the plant and environmental conditions). This explains why the application of NCP's is no general practice, despite their highly favourable environmental and toxicological properties.

It is thus a first object of the invention to improve the usefulness of NCP's.

It is a second object of the invention to provide the means to enhance the effectivity of synthetic pesticides so that the necessary amount thereof can be substantially lowered.

Control of weeds is another important problem in agriculture. In common agricultural practice a great variety of herbicides and other crop protection agents are used to reduce adverse effects of weeds or pathogens on crop yield. The world pesticides sales in 2000 amounted to US$ 31 billion. More than half of the costs that are spend by farmers on crop protection are for weed control. These costs have an effect on the price of agricultural products.

Since herbicide applications often negatively affect the environment, governmental policies aim at reducing the use of herbicides. In several European countries policy documents have been drafted in which farmers are being forced to achieve substantial reductions in the use of herbicides.

Organic farming is of growing importance world-wide. An organic farmer is not allowed to use any chemical herbicides. Since mechanical methods like hoeing often do not result in sufficient weed control, very expensive hand-weeding is required to solve weed problems on organic farms. Agro-economic studies have shown that the presently required amount of hand-weeding is one of the major constraints for a further increase of organic farming in countries like the Netherlands.

An important factor to achieve reductions in the use of herbicides is the development of preventive or alternative methods for weed control. Possibilities to prevent weed germination and establishment are essential components of modern strategies for weed control or what is called “integrated weed management”. Moreover, insights in the competitive relation between crop and weeds have led to the conclusion that a complete elimination of the weeds is often not necessary. Negative effects occur only above a minimum weed development. Also the crop itself can play a role in weed control, provided that the development of the crop is ahead of the growth of weeds.

Weed growth can be inhibited by establishing a top-layer on the soil or substrate that has a sufficient mechanical strength to prevent weeds from emerging. The top-layer can be either formed after emergence of the crop plants or before sowing depending on the ability of the crop plants to penetrate this layer. The formation of a top-layer inhibiting weed emergence is for example described in the international patent application WO-01/35747 of the same applicant.

WO-01/35747 discloses the use of lignosulfonates for the formation of a top-layer. However, the obtained top-layer can be further improved.

It is thus a further object of the present invention to provide a new top-layer forming composition for effectively controlling weed growth which is environmentally friendly and relatively cost-effective.

Another threat encountered in agriculture worldwide consists of plant-parasitic nematodes, which attack almost all crops. Damage estimates range from 5-25% yield reduction, but 100% losses occur locally, due to plant death or quality loss.

Nematodes are conventionally managed by crop rotation and chemical control. Crop rotation often is not an efficient tool for nematode management, due to the large host range of some of the nematode species and the lack of resistant crops or plant varieties.

Chemical control often uses compounds that are hazardous to the environment and the user. Many effective nematicides have been banned due to these risks. A widely used and effective nematicide, methyl bromide, is banned in the USA and will be banned in the EU shortly, leaving the farmers with very little management options for solving nematode problems. Biological control could be an alternative to chemical control, but at the moment no effective commercial nematode bio-control products are available on the European or American market.

It is therefore another object of the invention to provide compositions for the control of nematodes.

Plants are furthermore subject to various stress factors that are not caused by living organisms. These so-called abiotic stress factors, such as heat, cold, drought, salt, nutrient deficiency, can also lead to a lower yield and reduce the quality of the produce.

It is therefore another object of the present invention to provide new means to protect the plant from abiotic stress factors.

Yet another problem encountered in the agricultural industry is bad quality of produced products. Examples are apples with pale colour, tomatoes and grapes with little taste, flowers without scent etc. These quality problems are often related to the very controlled and optimized conditions of production. Induction of the right level of stress at a certain time point during crop development will optimally induce the secondary metabolism related to colour, taste or scent.

Therefore, it is also an object of the present invention to provide a composition for inducing a higher quality of crop products.

In the research that lead to the present invention it was surprisingly found that all the above-identified problems can be solved by compositions that comprise one or more poly-phenols and one or more other active ingredients. The use of one or more poly-phenols is the common concept of all compositions according to the invention. The other active ingredient determines the particular utility.

Examples of suitable sources of poly-phenols are lignosulfonates, humic acids, fulvic acids, and compost tea's (i.e. water extracts of compost). Lignosulfonates are particularly preferred.

Lignosulfonates are a derivative of lignin and the commercially available form thereof. Lignin is a naturally occurring component of plant cell walls (e.g. in wood), and one of nature's most plentiful and renewable resources. The lignosulfonate molecule is complex and can enter into many types of chemical reactions. This versatility allows it to be modified into a whole family of special chemicals.

Lignosulfonate (LS) is a by-product of the paper manufacture obtained from the spent sulfite pulping liquor of wood. It is a complex mixture of polymers with sulfonate groups attached to the molecules, and may contain a substantial amount of reducing sugars. Particularly the sulfonate groups provide LS with cation exchange properties, e.g. for ammonium and metal ions. Because lignosulfonates are a waste product of the paper industry they are generally available and can be used in the composition at relatively low costs. In addition, lignosulfonates are biodegradable, eco-friendly and safe for agricultural use.

According to a first aspect of the invention an antimicrobial composition is provided that comprises lignosulfonates (LS) and one or more ingredients selected from the group consisting of natural crop protection compounds (NCP's), metals and acids.

The invention thus relates to the application of NCP's, metals or acids in combination with one or more specific sustainable products that provide a synergistic or additive effect, and/or protect the plant against phytotoxic activity of the NCP's. These specific sustainable products are biodegradable and eco-friendly. A particular suitable example of a sustainable product is lignosulfonate (LS) and products derived thereof.

It should be noted that some acids and some metals can also qualify as NCP's. The composition of the invention can comprise only one compound selected from the group of NCP's, metals and acids or any combination between one or more members of these groups.

In addition to the above combinations the composition can further comprise chemical antimicrobial compounds, in particular chemical pesticides, more in particular chemical fungicides. The invention thus provides the combined application of reduced amounts of synthetic pesticides, NCP's and/or metals and/or acids and one or more sustainable products that provide a synergistic or additive effect, and/or prevents the plant against phytotoxic activity of the NCP's. Here also the sustainable product is preferably LS.

It was thus found according to the invention that by combining the active ingredient with LS the effectiveness of the active ingredient can be enhanced and/or the plant to be treated can be protected from the phytotoxicity of the active ingredient.

It was particularly surprising to find that by using them in combination with LS some metals that are in itself toxic to fungi and yeasts can be used in much lower amounts for achieving a comparable effect. The combination of chemical fungicides and metal-LS and/or acid-LS were found to be particularly effective.

The metals that were found to be particularly useful in the invention are copper, zinc, aluminium, titanium, silver, cobalt and manganese. The metal-LS have a particularly good activity against fungi and algae.

In a particular embodiment of the present invention either titanium (TiLS) and/or silver lignosulfonates (AgLS) are used. The use of titanium and/or silver further enhances the anti-microbial effect of the composition. TiLS contains TiO₂. The finely distributed TiO₂ catalyses in UV irradiation the formation of oxygen radicals that have biocidal activity. TiO₂ is not toxic for humans (it is for instance present in tooth paste). Silver lignosulfonates release Ag-ions in an aqueous environment. Ag-ions are toxic for micro-organisms and therefore contribute to the effectivity of the composition.

In a specific embodiment it was found that copper lignosulfonates (CuLS) are very effective in enhancing the activity of the chemical fungicide Shirlan®. Envisioned is a reduction of Shirlan of 50-90%.

Copper is known for its fungicidal activity. However, to be effective kilograms of copper compounds such as copper sulphate or copper oxide per hectare are needed. From an environmental point of view this is far too much and these copper compounds were thus banned as a crop protection agent. From the examples it follows that according to the invention, when combined with lignosulfonate, the amount of copper can be reduced to tens of grams per hectare thus making copper again available as a crop protection agent.

In a further embodiment LS is coupled to or used in combination with acids. It was found that these so-called acid-LS have an antimicrobial effect of their own or can be used in combination with metal-LS and/or chemical and/or natural crop protection agents, like fungicides.

Acid-LS can be prepared with any acid but particularly suitable are organic acids such as formic acid, propionic acid, citric acid, acetic acid, pelargonic acid, lactic acid, sorbic acid, ascorbic acid, etc. Inorganic acids that may be used are for example hydrochloric acid, phosphoric acid, sulphuric acid, boric acid, nitric acid, etc. The ratio between LS and acid lies in the range from 10 to 60, preferably 20 to 40. Acid-LS can be prepared from the constituent ingredients.

Natural crop protection compounds are agents that are of natural origin and protect plants or plant products against organisms or prevent the organism's activity; influence life processes of plants without being fertilizers; conserve plant products, kill unwanted plants; or destroy plant parts or prevent or inhibit unwanted growth of plants. Lists of NCP's can be found on http://www.gewasbescherming.nl/index10i.html.

In a particular embodiment of the invention the one or more natural crop protection compounds are for example selected from a first group of plant protection compounds consisting of natamycin, blasticidin-S, kasugamycin, mildiomycin, oxytetracycline, polyoxins (polyoxin B and polyoxorim), streptomycin, and validamycin. Natamycin is especially preferred. The one or more natural crop protection compounds are alternatively selected from a second group of plant protection compounds consisting of carvone, carvacrol, Citrex Liquid™ (an organic compound, derived from natural organic acids mixed with ascorbic acids), chitosan, thyme oil, azadirachtin, eucalyptus oil, harpin, potassium phosphite, nisin, lactoperoxidase, and nerolidol. In a preferred embodiment, one or more compounds from both groups are combined.

In a particular embodiment, the NCP is natamycin which is very sensitive to light. The combination with lignosulfonates allows natamycin to be applied to leaves, while retaining its activity.

Lignosulfonates not only lower the phytotoxicity of NCP's but protect the anti-microbial compounds in the composition against degradation thus allowing for their use in agriculture. Furthermore, lignosulfonates provide an synergistic effect by making the plant less susceptible to the anti-microbial compounds and increasing the effect of such compounds.

The metal-LS and acid-LS of the invention can also be used in combination with chemical antimicrobial agents (pesticides, in particular fungicides). It was found that the LS compounds greatly enhance the activity of the chemical. Thus a lower amount of the chemical can be used for achieving the same effect as compared to use of the chemical without LS.

The chemical crop protection agent can be any known or future product. Examples are Shirlan® (active ingredient: 2,6-dinitroaniline, or 3-chloro-N-[3-chloro-2,6-dinitro-4-(trifluoromethyl)phenyl]-5-(trifluoromethyl)-2-pyridinamine), Mirage® Plus (active ingredients: folpet en prochloraz), Carbendazim (active ingredient: methyl benzimidazol-2-ylcarbamate), Allure® (active ingredients: chlorothalonil (tetrachloroisophthalonitrile) and prochloraz (N-propyl-N-[2-(2,4,6-trichlorophenoxy)ethyl]imidazole-1-carboxamide or 1-{N-propyl-N-[2-(2,4,6-trichlorophenoxy) ethyl]}carbamoylimidazole)), Euparene (active ingredient: dichlofluanid or N-dichlorofluoromethylthio-N′,N′-dimethyl-N-phenylsulfamide), Folicur® (active ingredient: tebuconazole or alpha-[2-(4-chlorophenyl)-ethyl]-alpha-(1,1-dimethylethyl)-1H-1,2,4-triazole-1-ethanol). Of these Shirlan® was found to be particularly useful in combination with CuLS.

“Metal-LS” as used in this application is intended to refer to the combination of any one or more metals with LS. The metal can be either complexed to LS (e.g. as counter ions) or can be used in the same composition or at the same time as LS.

The term “acid-LS” as used in this application is intended to refer to the combination of any one or more acids with LS. The acid can be either complexed to LS or can be used in the same composition or at the same time as LS.

“At the same time” in these definitions does not necessarily mean that the metal or acid and LS are to be present during the complete same period of time but their presence in or on the plant part can also overlap only partially. “In the same composition” does not necessarily mean that the two or more ingredients are to be present in one composition before administration to the plant or plant part but that at some time during the treatment the two or more ingredients are in contact. This can thus also mean that one ingredient is applied after the other.

Antimicrobial, in particular fungicidal compositions of the invention are even more effective when used in a formulation that allows the active ingredient to remain in contact with the plant or plant part for a prolonged period of time. It is for example in particular useful to administer the composition of the invention in a form that prevents the composition from rolling of the leaves etc. to which they are administered. Compositions of the invention may thus further comprise compounds which facilitate the spreading, the effectivity, stability, etc. of the compositions. Examples of such compounds are detergents, buffers, chelators, spreading agents, preservatives.

The composition with anti-microbial function can be applied to plants as a solid, but can also be applied in solution. The solution can be applied onto the crop plants using methods known to the person skilled in the art but is preferably applied by spraying. Spraying allows for an even distribution of the composition.

Because of the excellent anti-microbial characteristics of the composition of the present invention, the composition can be used for protection of growing crop plants but can also be used for decontamination and subsequent preservation and protection of plant parts, such as seeds and bulbs, against pathogenic micro-organisms.

The skilled person is very well capable of designing the most useful formulation for a particular application.

According to a further aspect of the present invention, compositions are provided for controlling weed growth by forming a surface layer on soil or substrate which composition comprises one or more poly-phenols and small particles of organic material as the other ingredient. Preferably, the organic material is fibrous organic material, selected from the group consisting of saw dust, wool, cotton, rock wool, finely grinded plant material, such as grass, cellulose. Such organic material may have received a heat treatment to increase its resistance to microbial decay. Because of its fibrous nature a structure is formed wherein the fibres are randomly dispersed providing a matrix of maximal strength. The second component, the poly-phenols, in particular lignosulfonates, provide the adhesion component of the randomly dispersed fibrous material thereby making the matrix resistant to environmental conditions like rain, wind, etc. In addition, the poly-phenols provide additional mechanical strength to the matrix. Compared to known top-layers that consist solely of lignosulfonates, it is found that the combination with small particles of organic material leads to a better distribution. Moreover, the lignosulfonates are washed out to a lesser extent.

The ratio between lignosulfonates and organic material is between 1:5 and 5:1 by weight, preferably between 1:1 and 4:1, more preferably between 1:3 and 3:1 and even more preferably between 1:2 and 2:1 by weight, most preferably 1:1 by weight. Using this ratio, a matrix is obtained with excellent mechanical strength and minimal volume.

Sometimes straw is used to protect plants against frost. According to the invention, the straw can be combined with LS. A typical example of the ration between LS and straw for such application is 1:5 to 1:20, in particular 1:10.

Preferred fibrous organic material is pulverized plant material or pulverized processed plant material. The use of plant materials as fibrous material provides a generally available source of fibrous material. In addition, plant material is biodegradable providing an extra source of nutrients to the growing crop plants. The use of processed plant materials provides an additional advantage because it is a by-product of other processes used to obtain valuable compounds or extracts and thus an economically attractive source of fibrous waste material.

According to a particular embodiment of the present invention pulverized grass is used as a fibrous material. Grass is usually readily available and because it can be obtained locally, transportation costs are generally low.

According to another embodiment saw dust is used as a fibrous material. Saw dust is a waste product of the wood industry, can easily be obtained in large quantities and can be handled in a simple manner.

Both grass and saw dust may have been heat-treated to increase the durability of the protective top-layer.

In addition to the protective function of lignosulfonates, these compounds show an allelopathic effect by inhibiting weed germination and growth while not affecting the crop. Thus, they further enhance the effectivity of the composition.

Lignosulfonate is in general complexed with Ca²⁺, but can also be complexed with other organic and inorganic cations.

In one embodiment of the invention, the lignosulfonate component of the composition comprises at least in part ammonium lignosulfonate and/or potassium lignosulfonate. These two cations are valuable nutrients for crop plants. Because lignosulfonate is an ion exchange material it can be used to add these nutrients to the soil by exchanging the ions with less desirable ions present in the soil or substrate. This way, nutrients can be easily added. Since ammonium and potassium are thus slowly released from the top-layer a sustained-release formulation is provided to the growing crop plants.

The metal-LS of the invention have also sustained-release properties when the metal is complexed to the LS. It is within the general knowledge of the average skilled person to prepare complexed metal-LS.

Because the top-layer functions as a sustained-release matrix also other compounds can be added to the formulation which enhance the growth of crop plants like trace elements like copper, molybdenum, boron, zinc, manganese, cobalt; plant nutrients, such as nitrogen, potassium, magnesium; anti-microbial agents like carvacrol, azadirachtin, and other NCP's as mentioned in this application.

The present invention also provides a method for controlling weed growth which method comprises applying the composition to the soil or substrate in which the crop plants are or will be growing. The composition can be applied in solution. Suitable solvents are solvents such as water, ethanol, essential oils, etc.

The solution can be applied onto the soil or substrate using methods known to the person skilled in the art, but is preferably applied by spraying. Spraying allows for an even distribution of the solution resulting in a top-layer with an evenly distributed thickness.

The top-layer can also be formed using a solid composition. The top-layer is then formed after the solid composition has been in contact with water, such as rain. The solid composition is less susceptible to biodegradation than the solution and can therefore be stored during a prolonged period of time. The solid can also be applied by hand and is lighter than the solution since it contains no solvent. This is advantageous in areas with less mechanized agriculture or in areas which are difficult to reach with machines.

Effective weed control is obtained by applying the composition according to the invention in an amount of 200, 500, 1200, 1900, 2400, 3100 and 4000 kg/ha, thus in the range of 200-4000 kg/ha, preferably 400, 700, 900, 1100, and 1200 kg/ha, thus in the range of 400-1200 kg/ha, more preferably 900, 950, 1050, and 1100 kg/ha, thus in the range of 900-1100 kg/ha.

According to another embodiment, the external threat is abiotic stress, such as drought, salt, heat, cold, nutrient deficiency, and the composition comprises lignosulfonates and one or more compounds that induce stress tolerance, for example selected from the group consisting of abscisic acid, chitosan, ethylene, salicylate, jasmonate, nonanoic acid.

Alternatively, the composition comprises lignosulfonates and one or more compounds that stimulate wound repair and growth, for example selected from the group consisting of cytokinins, gibberellins, brassinosteroids, auxins.

It is also possible to combine the lignosulfonates with one or more compounds that induce stress tolerance as defined above and one or more compounds that induce wound repair and growth as defined above.

Also part of the invention is the use of lignosulfonates alone, i.e. without other active ingredients, to induce stress tolerance. Additional compounds may further increase the stress tolerance and are therefore preferred but are not essential for inducing stress tolerance.

According to yet another aspect thereof, the invention relates to compositions for improving the quality of the products of the crop, which composition comprises lignosulfonates, a chelator and optionally a terpene. The chelator is preferably EDTA or EDDHA (ethylenediaminedi(o-hydroxyphenylacetic) acid).

The terpene can be selected from thyme oil, clove oil and carvacrol. It was surprisingly found that when applied to fruits, like apples, the composition induces an improvement of the quality of this fruit. “Improved quality” as used herein is intended to mean any improvement in colour, taste, scent, and structure of the fruit as compared to the untreated fruits. With respect to apples, it was found that when applying a composition comprising lignosulfonates, a chelator, such as EDTA, and a terpene, such as di-1-p-menthene, to apple fruits four weeks and two weeks before harvest results in a strong increase in the formation of red colour on the skin of the apples. Also, it was found that the uniformity of the harvested product was largely increased. This leads to a better price of the product and reduced harvesting costs. Di-1-p-menthene and EDTA allow for the equal spreading of the composition on fruits thereby enhancing the quality improving effects of the composition according to the invention.

In addition, a composition is provided for the protection of plants against nematodes, comprising lignosulfonates in combination with a cellulose containing material, such as cellulose, compost or finely grinded plant material. This composition is applied into the substrate in which the plant is growing, usually soil or artificial substrates. Application of the composition will be most efficient in systems where final yield is highly determined by plant establishment and by the first period of growth. Specific situations in which lignosulfonates and cellulose containing materials can be used are described hereinbelow. These examples are, however, not intended as limitations.

Protection of sugar beet seedlings against nematode attack (for instance against Heterodera schachtii and Paratrichodorus teres) can be obtained by in-furrow application of lignosulfonates and cellulose slurry at seeding.

For potatoes, it is possible to coat seed potatoes with lignosulfonates and cellulose or apply lignosulfonates and cellulose slurry at planting of the tubers. This will protect the potato plant against early attack by Pratylenchus, Paratrichodorus, Globodera, Meloidogyne and other nematodes, that are most harmful during the first period of potato growth.

Protection of tulips against tobacco rattle virus, which is transmitted by Paratrichodorus and Trichodorus nematodes, can be achieved by coating of tulips or application of lignosulfonate slurry with compost upon planting. Tulip is sensitive to tobacco rattle virus transmission only for a limited period after planting and the strong effect of lignosulfonates on the vector nematode Paratrichodorus teres shows that virus transmission will be inhibited.

A further application of lignosulfonates and cellulose is for amelioration of replant problems. Replant problems are often caused by nematodes, that attack young trees or shrubs that are replanted at a site were the same crop was grown before. Addition of lignosulfonates and cellulose slurry in the plant hole will inhibit nematode (Pratylenchus, Meloidogyne and others) attack and give the young plant a better chance of establishing a vital root system.

(Re)planting can take place in soil but also in other substrates, such as potting soil, vermiculite, coconut fibres etc. These substrates can also be pre-treated with the composition of lignosulfonates and cellulose containing material. Such pre-treated substrates for plant growth are also part of this invention.

The invention furthermore relates to the use of lignosulfonates and cellulose containing materials in the applications described above and to compositions that contain lignosulfonates and are intended for the above identified use.

Compositions according to the invention for controlling nematodes comprise lignosulfonates (LS) in an amount to meet the desired goal as described above. An optimal amount lies usually around 0.05 kg/m². The compositions take usually the form of a solution or slurry that can be sprayed or poured. Such solution contains about 10-55%, preferably around 30% LS. LS does usually not dissolve above an amount of 55% without additional measures.

Effective nematode control is obtained by applying the composition according to the invention in an amount of 10, 20, 50, 100, 250, 600, 950, 1200, 1550 and 2000 kg/ha, thus in the range of 10-2000 kg/ha, preferably 200, 350, 450, 550, and 600 kg/ha, thus in the range of 200-600 kg/ha, more preferably 450, 475, 525, and 550 kg/ha, thus in the range of 450-550 kg/ha.

The invention further relates to methods for protecting plants and plant parts against weeds, pathogens and other stresses wherein compositions of the invention are applied to soil, substrate, plant or plant part.

Lignosulfonate is typically a mixture of more or less degraded lignin residues of different sizes. This mixture can be fractionated and/or treated chemically. When used in this application the terms “lignosulfonate” and “lignosulfonates” are intended to mean both crude, untreated forms of lignosulfonate as well as more or less purified and/or chemically modified lignosulfonate or fractions thereof.

Lignosulfonates can thus be either a mixture or isolated lignosulfonate molecules. Usually a crude mixture is used, but the invention may in some applications, such as immunization, benefit from the use of pure LS. Crude mixtures still contain 5 to 10% reducing sugars that may lead to stickiness of plant parts, such as leaves, when a solution thereof is sprayed onto the plant or applied to the plant otherwise. Crude mixtures are however more cost-effective as they do not require a further fractionation to remove the sugars. Lignosulfonates used according to the invention are usually Ca-lignosulfonates or NH₄-lignosulfonates.

As used in this application the term “active ingredient” is intended to mean any ingredient that contributes to the function of the composition.

The invention will be further exemplified with reference to the following figures and examples. However it should be understood that these figures and examples are not intended to limit the invention in any possible way.

The figures show:

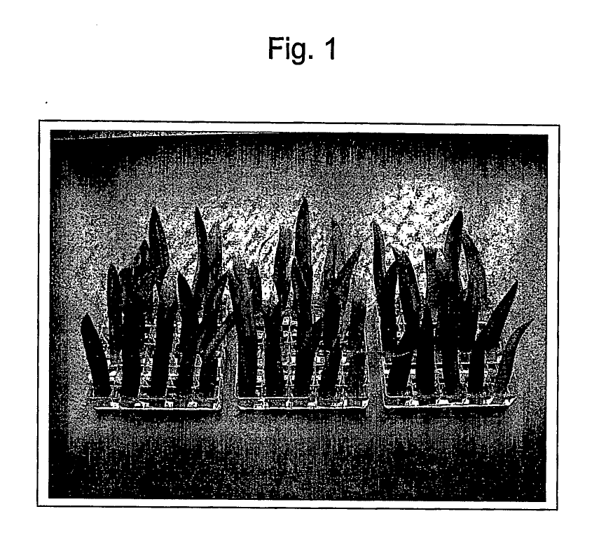

FIG. 1: Effect of CaLS and natamycin on development of Botrytis elliptica on lily leaf tips. At the left: control (no treatment); in the middle: treatment with formulation; at the right: treatment with formulated natamycin. The formulation contained 0.5% (v/v) CaLS, 0.08% EDTA and 0.007% NU-FILM-17 (a non-ionic sticker/spreader; Miller).

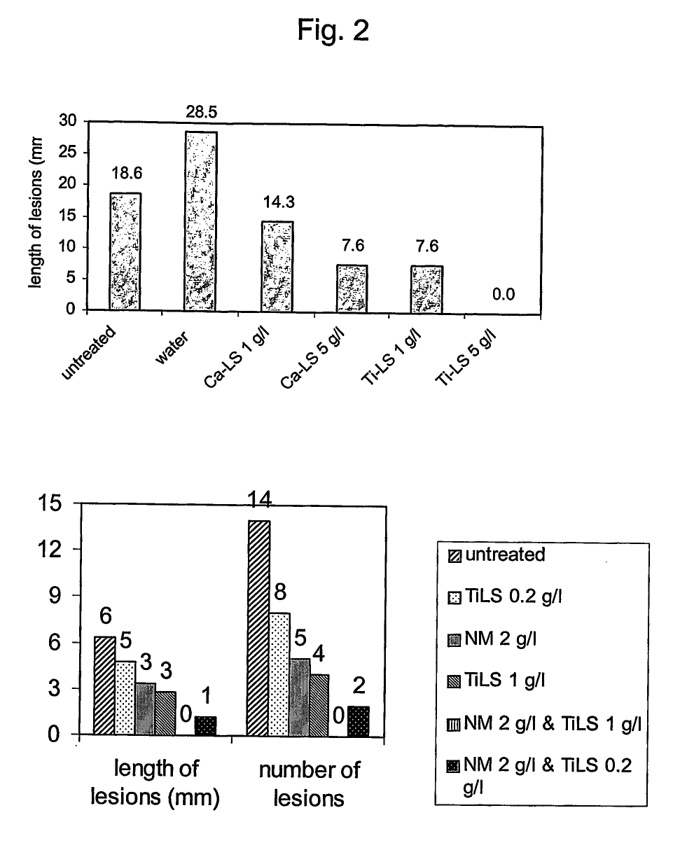

FIG. 2: Effect of TiLS, CaLS and natamycin on development of Botrytis elliptica on lily leaf tips. Upper panel: effect of TiLS and CaLS. Lower panel: effect of (combinations of) natamycin and TiLS.

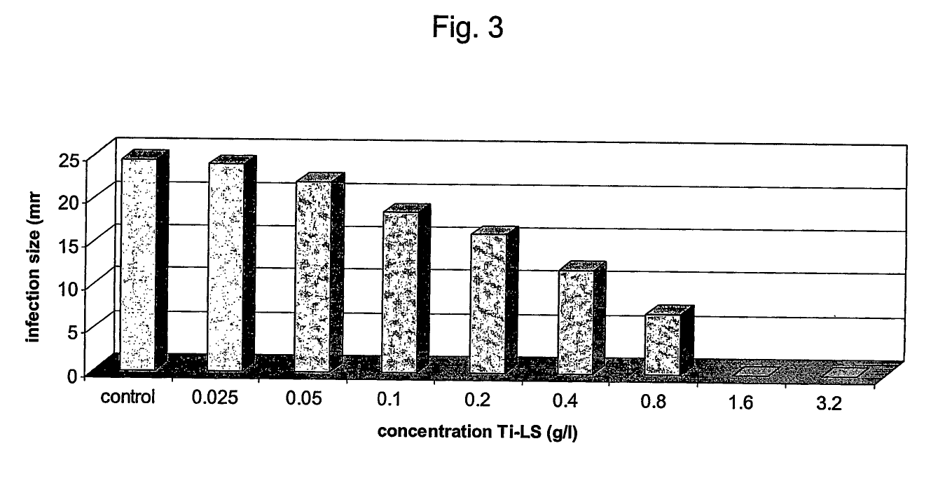

FIG. 3: Effect of Titanium-LS on growth of Botrytis on petri dishes with nutrient broth growing medium.

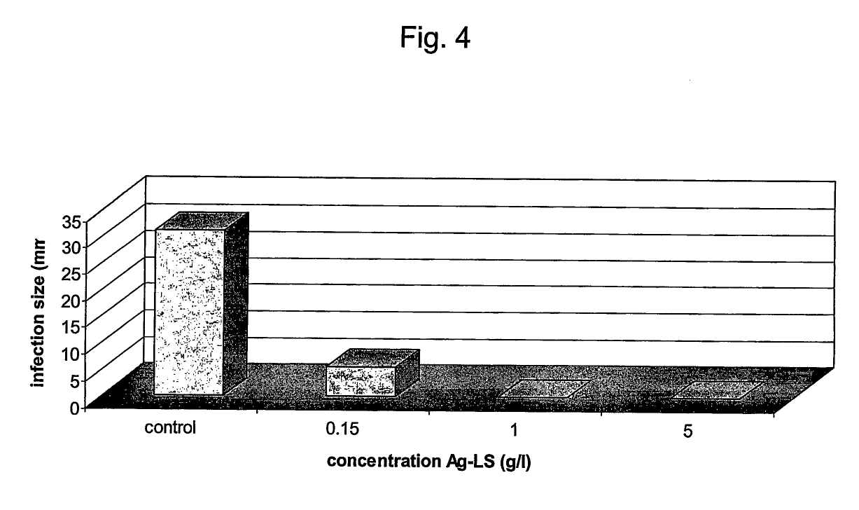

FIG. 4: Effect of Silver-LS on growth of Botrytis on petri dishes with nutrient broth growing medium.

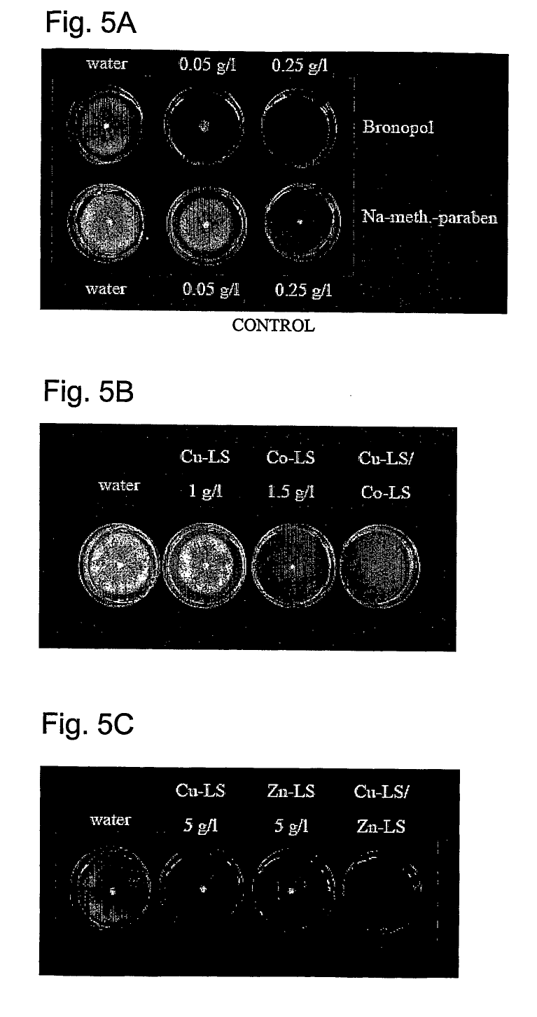

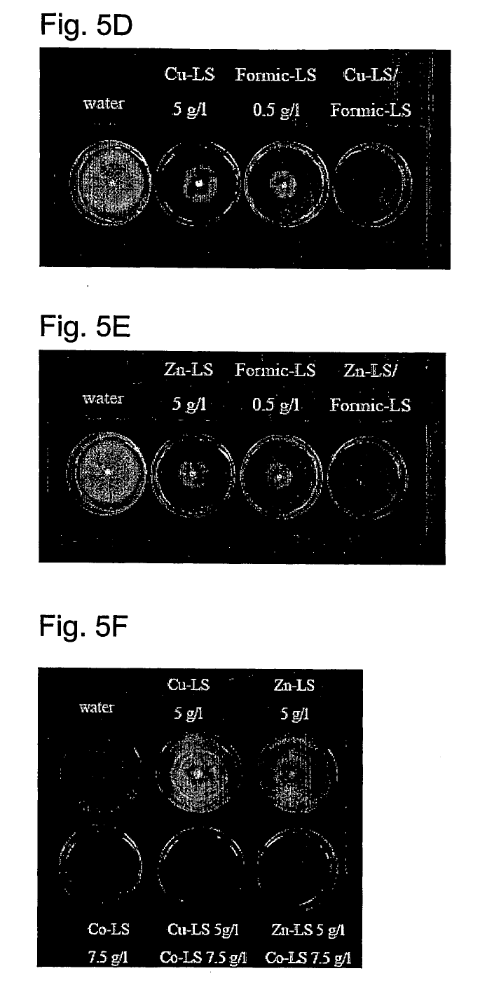

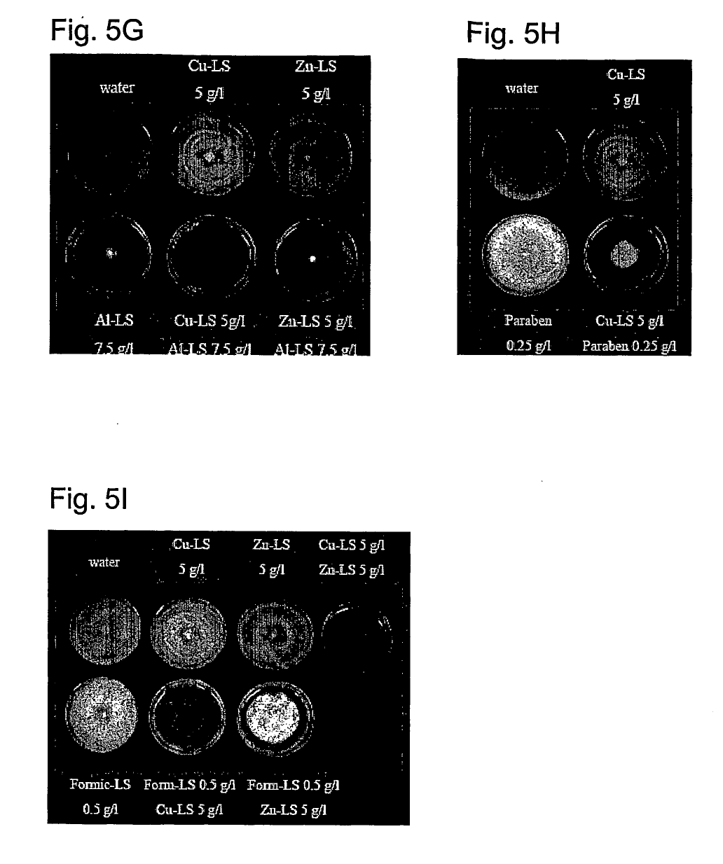

FIG. 5: Petri-dishes showing the effect of different combinations of metal-LS and/or preservatives on the growh of Botrytis cinerea.

FIG. 5A: top row shows the effects after 3 days of water control treatment and bronopol treatments; bottom row shows the effects after 3 days of water control treatment and sodiummethylparabenzoic acid treatments.

FIG. 5B: From left to right: effects of water, 1 g/l copper-LS (Cu-LS), 1.5 g/l cobalt-LS (Co-LS) and the combination of 1 g/l Cu-LS and 1.5 g/l Co-LS after 3 days.

FIG. 5C: From left to right: effects of water, 5 g/l copper-LS (Cu-LS), 5 g/l zinc-LS (Zn-LS) and the combination of 5 g/l Cu-LS and 5 g/l Zn-LS after 3 days.

FIG. 5D: From left to right: effects of water, 5 g/l copper-LS (Cu-LS), 0.5 g/l formic acid-LS (Formic-LS) and the combination of 5 g/l Cu-LS and 0.5 g/l Formic-LS after 3 days.

FIG. 5E: From left to right: effects of water, 5 g/l zinc-LS (Zn-LS), 0.5 g/l formic acid-LS (Formic-LS) and the combination of 5 g/l CU-LS and 0.5 g/l Formic-LS after 3 days.

FIG. 5F: Upper panel from left to right: effects of water, 5 g/l copper-LS (Cu-LS), and 5 g/l zinc-LS (Zn-LS) after 7 days; bottom row from left to right: effects of 7.5 g/l cobalt-LS (Co-LS), the combination of 5 g/l Cu-LS and 7.5 g/l Co-LS, and the combination of 5 g/l Zn-LS and 7.5 g/l Co-LS after 7 days.

FIG. 5G: Upper panel from left to right: effects of water, 5 g/l copper-LS (Cu-LS), and 5 g/l zinc-LS (Zn-LS) after 7 days; bottom row from left to right: effects of 7.5 g/l aluminium-LS (A1-LS), the combination of 5 g/l Cu-LS and 7.5 g/l Al-LS, and the combination of 5 g/l Zn-LS and 7.5 g/l Al-LS after 7 days.

FIG. 5H: Upper panel from left to right: effects of water, and 5 g/l copper-LS (Cu-LS) after 7 days; bottom row from left to right: effects of 0.25 g/l sodiummethylparabenzoic acid (Paraben), and the combination of 5 g/l Cu-LS and 0.25 g/l Paraben after 7 days. FIG. 5I: Upper panel from left to right: effects of water, 5 g/l copper-LS (Cu-LS), 5 g/l zinc-LS (Zn-LS), and the combination of 5 g/l Cu-LS and 5 g/l Zn-LS after 7 days; bottom row from left to right: effects of 0.5 g/l formic acid-LS (Formic-LS), the combination of 0.5 g/l Formic-LS and 0.5 g/l Cu-LS, and the combination of 5 g/l Zn-LS and 0.5 g/l Formic-LS after 7 days.

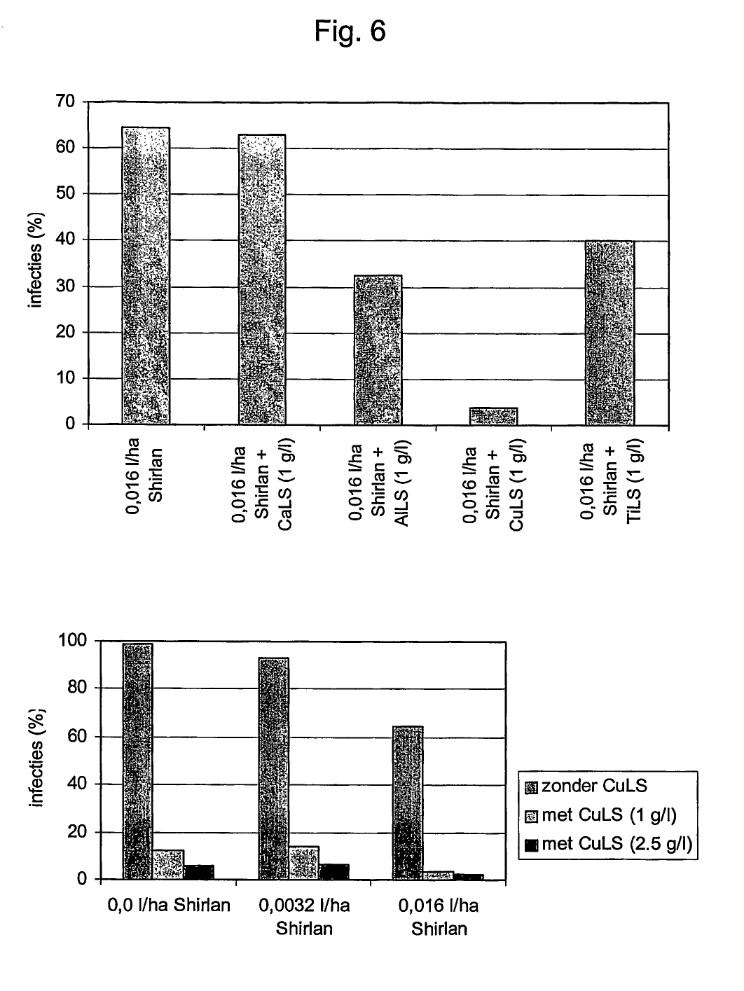

FIG. 6: Effects of different treatments of Phytophthora infestans leaf infections (expressed as percentage of total leaves) in potato. Three days after spraying with the different LS-compounds the potato plants were inoculated with Phytophthora. One week after inoculation the effects were monitored. The upper panel shows the effects of different metal-LS compounds compared to the effect of a sub-optimal concentration of the synthetic fungicide Shirlan®. The lower panel shows the effect of three concentrations of copper-LS (CuLS) in combination with three concentrations of Shirlan®.

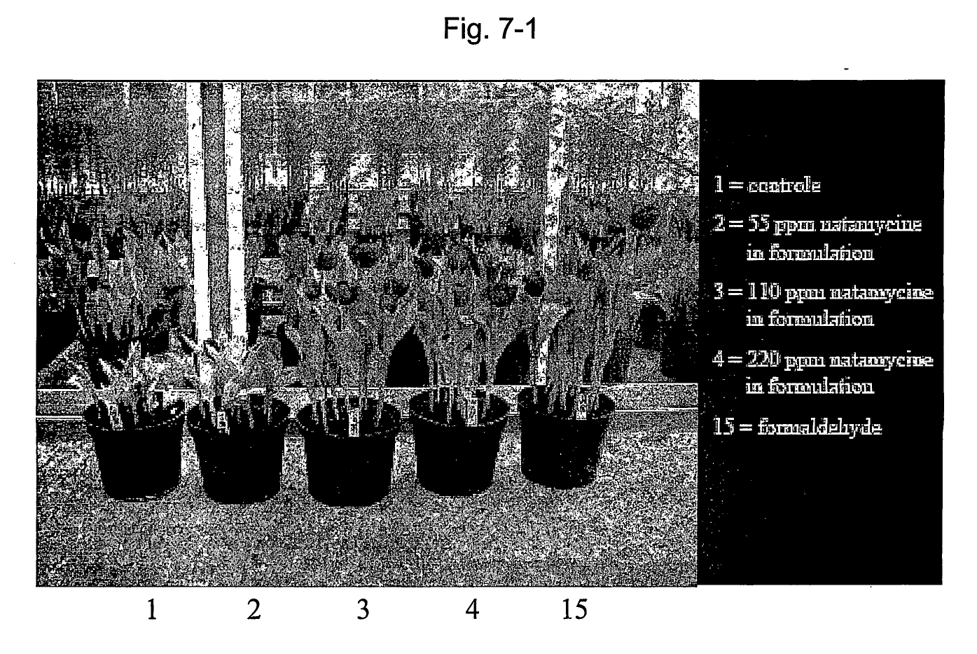

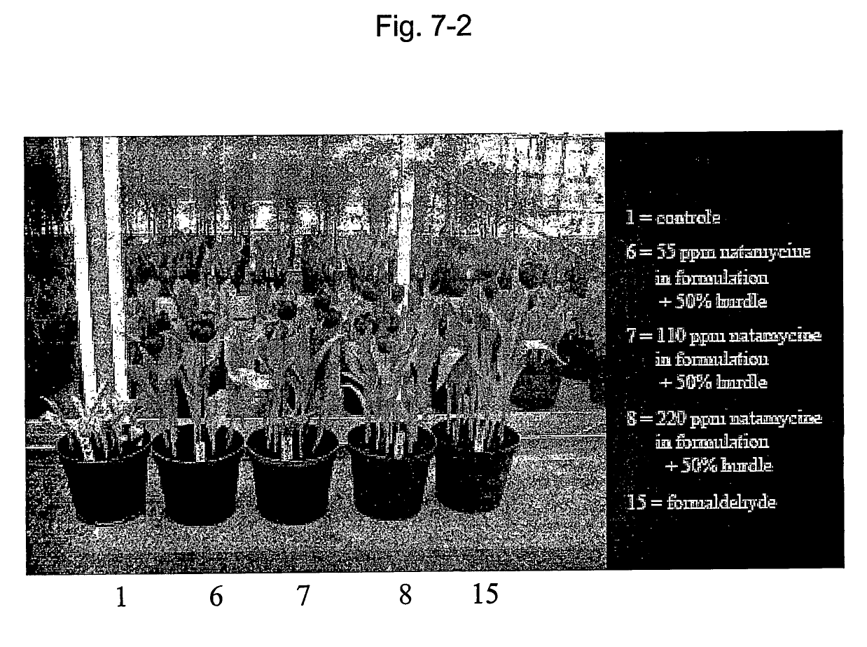

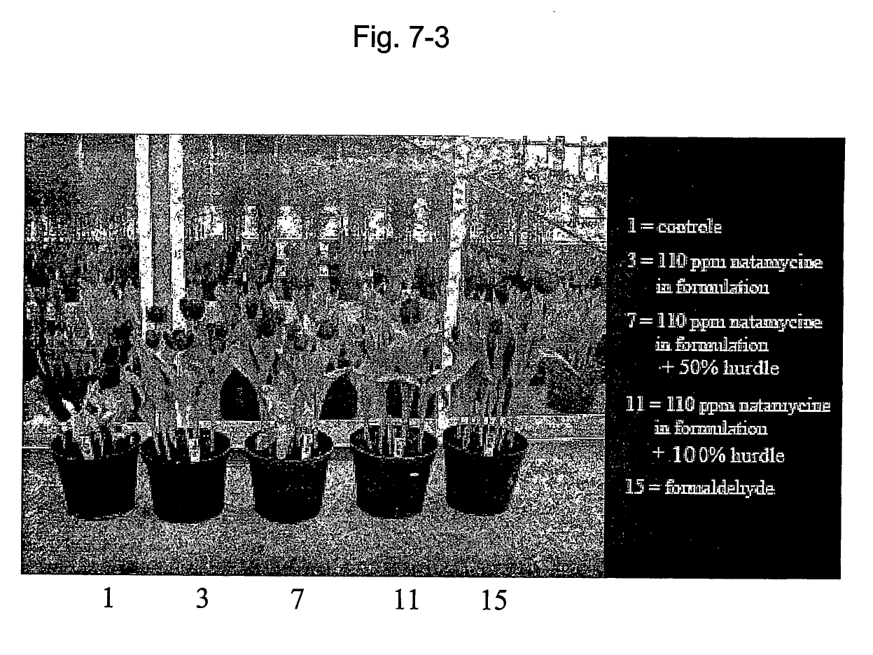

FIG. 7: Effects of (various combinations of) formulated natamycine and the hurdle-product (see text of Example 11) on tulip bulbs infected with Fusarium (see Example 10 for inoculation procedure) in comparison to the effects of control (untreated) and of treatments with 0.5% formaldehyde.

### EXAMPLES

### Example 1

Protection of Solanum niger Plants from Stress Induced by Low Dosages of Herbicides

In an experiment Solanum niger plants were grown for 6 weeks after sowing. The plants were then sprayed with a sub-optimal level of herbicide (either with 6% of the recommended dosage of Round up, containing the active compound glyphosate, or with 10% of the dosage recommended on the label of 2,4 D, respectively). Groups of plants were sprayed with a mixture of the low dosage of the herbicide and different concentrations and types of LS (see table).

The results from table 1 show that LS induces stress tolerance to the low dosages of herbicides.

TABLE 1

| | | | Percentual increase | |
|---|---|---|---|---|
| | | | in dry weight | |
| | Round up | | compared to low | |
| | (glyphosate) | 2,4-D | herbicide | |
| | Dry weight (g) 6 weeks | | application | |
| Treatment | after treatment | | Round up | 2,4-D |
| control untreated | 2.4 g | 2.4 g | | |
| normal herbicide dosage | plants died | plants died | | |
| low herbicide dosage | 1.15 g | 1.05 g | | |
| low herbicide dosage + | 1.9 g | 1.85 g | 65% | 76% |
| 2 g/l calcium-LS | | | | |
| low herbicide dosage + | 1.6 | 1.3 | 39% | 24% |
| 10 g/l calcium-LS | | | | |
| low herbicide dosage + | 2.35 | 1.1 | 104% | 5% |
| 25 g/l calcium-LS | | | | |
| low herbicide dosage + | 2.05 | 1.25 | 78% | 19% |
| 10 g/l iron-LS | | | | |

### Example 2

Effect of NH₄-LS and a NCP, Carvacrol, on Infection (Lesions) of Botrytis elliptica on Lily Leaf Tops

In all incubations the amount of NH₄-LS was 5 g/l (the amount of carvacrol is given in the table).

In a test system, leaf tops of lily were used. For infection with pathogens, leaf tops were placed into special square plastic trays (10 cm×10 cm×2 cm) which were divided in 25 small sections of 2×2 cm (see FIG. 1). At the start of the experiments the trays were filled with water (4 ml per small section). Then the leaf tops were placed in the trays and finally the leaf tops were sprayed with the different LS-NCP combinations. In the table the combination of LS with carvacrol in a formulation of di-1-p-menthene and EDTA is given.

Twenty-four hours after treatment the leaf tops in the trays were infected with 2 ?l of Botrytis elliptica spore suspension (approximately 500 spores/?l, see below).

Subsequently, the plastic trays were put in a transparent container with high humidity. This container was placed in a temperature and humidity controlled greenhouse (12 hours of light, 20° C., and 400-600 ppm of CO₂).

Each tray contained 15 leaf tops and all experiments were performed in triplicate.

For Botrytis spore production, the fungus was grown on 25 ml sterile solid medium containing liquid broth. The spores were applied to the leaves in Gamborg B5 medium (Gamborg 3.16 g/l, Na-phosphate 10 mM pH=6.5, sucrose 10 Mm). After 3, 5 and 7 days incubation the size (mm) of the Botrytis lesions was measured.

Table 2 shows the results.

TABLE 2

| | Lesion size | Lesion size | Lesion size |
|---|---|---|---|
| | (mm) after 3 | (mm) after 5 | (mm) after 7 |
| Treatment | days | days | days |
| Control | 6.8 | 8.6 | 14.2 |
| (untreated) | | | |
| Control | 5.3 | 7.5 | 12.5 |
| formulation | | | |
| 5 g/l NH₄-LS/ | 0.9 | 1.8 | 2.7 |
| 0.2% carvacrol | | | |
| 5 g/l NH₄-LS/ | 0.2 | 0.3 | 0.3 |
| 0.8% carvacrol | | | |
| 5 g/l NH₄-LS/ | 0.1 | 0.5 | 1.2 |
| 1.6% carvacrol | | | |

### Example 3

Effect of LS and Natamycin on Development of Botrytis on Lily Leaf Tips

The same method was used as in Example 2. The leaf tops in the left tray were treated with water, the leaf tips in the middle were treated with the LS formulation without natamycin and the leaf tips in the incubator on the right were treated with LS-natamycin combination.

FIG. 1 demonstrates that natamycin formulated with LS protects very well against Botrytis. Natamycin-LS also protected against other fungi. Treatment with natamycin alone did provide adequate protection but also resulted in some leaf damage. The combination with LS is thus better.

### Example 4

Effect of Titanium-LS on Growth of Botrytis on Lily Tips

The experiment was performed as described in Example 2 with natamycin (2 g/l) and titanium-LS (0.2 g/l and 1 g/l). The results are shown in FIG. 2. The combination of natamycin and titanium-LS in an amount of 1 g/l leads to a complete absence of lesions.

### Example 5

Effect of Titanium-LS on Growth of Botrytis on Petri Dishes with Nutrient Broth Growing Medium

Botrytis spores were incubated on sterilized growing medium containing different concentrations of Ti-LS. The spores were placed on the middle of the petri dish and the infection size (diameter of the Botrytis-colony) was measured after 5 days. FIG. 3 shows the results.

The outcome of the experiment was that at a concentration lower than 1.6 g/l of Ti-LS development of Botrytis was already completely blocked.

### Example 6

Effect of Silver-LS on Growth of Botrytis on Petri Dishes with Nutrient Broth Growing Medium

Botrytis spores were incubated on sterilized growing medium containing different concentrations of Ag-LS. The spores were placed on the middle of the petri dish and the infection size (diameter of the Botrytis colony) was measured after 5 days.

FIG. 4 shows that at a concentration of lower than 1 g/l of Ag-LS development of Botrytis was completely blocked.

### Example 7

Effect of Metal-Lignosulfonates on the Growth of Botrytis on Petri Dishes

The effect of different lignosulfonate compounds on development of Botrytis cinerea and Botrytis elliptica spores incubated on growing medium containing malt-extract in vitro was tested. The malt extract was of the company Oxoid B.V. (Haarlem, the Netherlands) and the method used was according to the directions of the manufacturer.

The petri dishes were incubated at 20° C. for 3 days in the dark. Per petri dish 700 Botrytis cinerea and 600 Botrytis elliptica spores were incubated. The diameter of the fungus colony on the petri dish is given in table 3.

TABLE 3

Diameter (mm)

| Compound | B. cinerea | B. elliptica |
|---|---|---|
| water | 21 | 13 |
| (reference) | | |
| CaCl₂* (g/l) | | |
| (reference) | | |
| 0.006 | 21 | 14 |
| 0.028 | 20 | 13 |
| 0.138 | 21 | 12 |
| 0.686 | 21 | 12 |
| 1.375 | 21 | 12 |
| Ca-LS (g/l) | | |
| 0.04 | 21 | 13 |
| 0.2 | 20 | 13 |
| 1 | 20 | 11 |
| 5 | 15 | 9 |
| 10 | 15 | 8 |
| Zn-LS (g/l) | | |
| 0.04 | 20 | 14 |
| 0.2 | 20 | 13 |
| 1 | 17 | 12 |
| 5 | 8 | 5 |
| 10 | 0 | 1 |
| Cu-LS (g/l) | | |
| 0.04 | 22 | 14 |
| 0.2 | 20 | 15 |
| 1 | 18 | 12 |
| 5 | 13 | 7 |
| 10 | 4 | 0 |
| Co-LS (g/l) | | |
| 0.04 | 20 | 13 |
| 0.2 | 20 | 13 |
| 1 | 13 | 10 |
| 5 | 0 | 2 |
| 10 | 0 | 1 |
| Al-LS (g/l) | | |
| 0.04 | 22 | 13 |
| 0.2 | 20 | 13 |
| 1 | 19 | 12 |
| 5 | 16 | 10 |
| 10 | 0 | 1 |
| formic | | |
| acid/propionic | | |
| acid-LS (g/l) | | |
| 0.04 | 20 | 13 |
| 0.2 | 17 | 12 |
| 1 | 0 | 0 |
| 5 | 0 | 0 |
| 10 | 0 | 0 |
| Na-methyl-paraben | | |
| (g/l) (reference) | | |
| 1 | 0 | 0 |
| 5 | 0 | 0 |
| 25 | 0 | 0 |
| Bronopol (mg/l) | | |
| (reference) | | |
| 2 | 20 | 12 |
| 10 | 20 | 12 |
| 50 | 14 | 10 |

*The Ca concentration in CaCl₂ is equal to the Ca concentration in Ca-LS: the proportion of calcium in Ca-LS was approximately 5%.
Ca-LS = calcium lignosulfonate;
CaCl₂ = calcium chloride;
Zn-LS = zinc lignosulfonate;
Cu-LS = copper lignosulfonate;
Co-LS = cobalt lignosulfonate;
Al-LS = aluminum lignosulfonate;
formic acid/propionic acid LS = 34% formic acid + 7% propionic acid + 30% lignosulfonate + 29% water;
Na-methyl-paraben = sodium methyl para benzoic acid;
Bronopol = 2-bromo-2-nitro-1,3-propane diol.

The results show that the metal-LS compounds inhibit growth of both Botrytis cinerea and Botrytis elliptica.

### Example 8

Effect of Combinations of Metal-Lignosulfonates on the Growth of Botrytis on Petri Dishes

The same experiment as described in Example 7 was performed with combinations of metal- or acid-lignosulfonates with each other or with known fungicides. FIG. 5 shows the results after 3 (FIGS. 5A-E) and 7 days (FIGS. 5F-I).

It follows from this figure that combinations of two metal-LS or a metal-LS with a known fungicide or with an acid-LS can completely abolish growth of Botrytis cinerea in vitro.

### Example 9

Metal Lignosulfonates for Controlling Phytophthora infestans in Potato

Five potato plants were treated with the following lignosulfonate solutions in water:

1) 1 g/l calcium lignosulfonate (CaLS) (reference);

2) 1 g/l aluminium lignosulfonate (AlLS);

3) 1 g/l copper lignosulfonate (CuLS);

3a) 2.5 g/l copper lignosulfonate (CuLS);

4) 1 g/l titanium lignosulfonate (TiLS);

Three days after treatment the 5-10 leaves of each plant were inoculated at five locations with Phytophthora infestans. One week later the plants were evaluated. The results are found in table 4.

TABLE 4

| No. | metal-LS (g/l) | % infection |
|---|---|---|
| control | — | 98.8 |
| 1 (reference) | CaLS (1) | 98.8 |
| 2 | AlLS (1) | 81.3 |
| 3 | CuLS (1) | 12.5 |
| 3a | CuLS (2.5) | 5.6 |
| 4 | TiLS (1) | 100 |

It follows that CuLS alone significantly lowers the infection and is thus active on its own as a fungicide.

The effect of these lignosulfonates on the activity of the commercial fungicide Shirlan® (also known as fluazinam or 2,6-dinitroaniline, or 3-chloro-N-[3-chloro-2,6-dinitro-4-(trifluoromethyl)phenyl]-5-(trifluoromethyl)-2-pyridinamine; obtainable from Syngenta) was also tested. The experiment was performed as described above with the same metal lignosulfonates in the same concentration and in addition 0.0032 l/ha or 0.016 l/ha Shirlan®. The results are shown in table 5 and FIG. 6.

TABLE 5

| | | % infection | | |
|---|---|---|---|---|
| | metal-LS | 0 l/ha | 0.0032 l/ha | 0.016 l/ha |
| No. | (g/l) | Shirlan ® | Shirlan ® | Shirlan ® |
| control | — | 98.1 | 93.1 | 64.5 |
| 1 (reference) | CaLS (1) | 98.8 | 98.8 | 62.9 |
| 2 | AlLS (1) | 81.3 | 66.3 | 32.5 |
| 3 | CuLS (1) | 12.5 | 13.8 | 3.8 |
| 3a | CuLS (2.5) | 5.6 | 6.3 | 2.5 |
| 4 | TiLS | 100.0 | 85.0 | 40.0 |

It follows from table 5 and FIG. 6 that the metal-LS significantly enhances the fungicidal activity of Shirlan®, which is a clear synergistic effect.

### Example 10

Use of Acid-LS in Protection Against Fusarium in Tulip Bulbs

A composition containing 30% formic acid, 6% propionic acid, 20% LS and 44% water was used to treat tulip bulbs infected with Fusarium.

Five pots were filled with potting soil and 10 bulbs of the tulip cultivar Prominence, size 12/13. The bulbs were inoculated with Fusarium by a 15 minute dip in a solution heavily infected with Fusarium.

The results of the test are summarized in table 6.

TABLE 6

| | | plant status | | % Fusarium on bulb | | |
|---|---|---|---|---|---|---|
| | | after 1 | % bloom after 6 | heavy | light | |
| composition | infection | month* | weeks | infection | infection | total |
| not treated | not | 7.2 | 78 | 30 | 54 | 84** |
| | infected | | | | | |
| not treated | infected | 3.4 | 0 | 100 | 0 | 100 |
| 0.5% | infected | 10 | 100 | 0 | 22 | 22 |
| formaldehyde | | | | | | |
| (reference) | | | | | | |
| 1% | infected | 9.4 | 96 | 8 | 42 | 50 |
| composition | | | | | | |
| of the | | | | | | |
| invention | | | | | | |

*plant status varies from 0 (bad) to 10 (good)
**Fusarium infection could be naturally occurring or induced by dipping the bulb in a Fusarium solution

No phytotoxic symptoms were found during culture. The composition of the invention is very effective in treating Fusarium.

### Example 11

Use of Cu-LS in Combination with Natamycin in Protection Against Fusarium on Tulip Bulbs

The experiment was performed as described in Example 10 but with different treatments as summarized in table 7.

TABLE 7

| Number | Treatment |
|---|---|
| 1 (control) | water |
| 2 (reference) | 55 ppm natamycin in formulation |
| 3 (reference) | 110 ppm natamycin in formulation |
| 4 (reference) | 220 ppm natamycin in formulation |
| 6 | 55 ppm natamycin in formulation + 50% |
| | hurdle* |
| 7 | 110 ppm natamycin in formulation + 50% |
| | hurdle* |
| 8 | 220 ppm natamycin in formulation + 50% |
| | hurdle* |
| 11 | 110 ppm natamycin in formulation + 100% |
| | hurdle* |
| 15 | formaldehyde |

*100% Hurdle = Cu-LS (5 g LS + 0.25 g Cu per liter) + 15 μl/l 5-chloro-2-methyl-4-isothiazolin-3-one/2-methyl-4-isothiazolin-3-one (CIT/MIT in a 3:1 ratio) + 50 mg/l bronopol.

The results are shown in FIG. 7. Tulips that were treated with natamycin alone show some yellow spots on the leaves and along the leaf edges indicating that the bulbs are infected. Leaves of tulips treated with natamycin and Cu-LS did not show such spots.

1. Composition for protecting an agricultural crop against external threats and/or for improving the quality of the products produced by the crop, which composition comprises one or more poly-phenols and one or more other active ingredients.

2. Composition as claimed in claim 1, wherein the poly-phenol is selected from the group consisting of lignosulfonates, humic acids, fulvic acids, and compost teas.

3. Composition as claimed in claim 1, wherein the poly-phenol consists of lignosulfonates.

4. Composition as claimed in claim 3, wherein the active ingredient is not a chemical fungicide.

5. Composition according to claim 1, wherein the external threat consists of biotic stress caused by microorganisms, and the composition comprises lignosulfonates and one or more ingredients selected from the group consisting of natural crop protection compounds (NCP's), metals, and acids.

6. Composition as claimed in claim 5, further comprising chemical antimicrobial compounds.

7. Composition according to claim 5, wherein the one or more natural crop protection compounds are selected from a first group of plant protection compounds consisting of natamycin, blasticidin-S, kasugamycin, mildiomycin, oxytetracycline, polyoxins (polyoxin B and polyoxorim), streptomycin, and validamycin.

8. Composition according to claim 5, wherein the one or more natural crop protection compounds are selected from a second group of plant protection compounds consisting of carvone, carvacrol, CITREX LIQUID, chitosan, thyme oil, azadirachtin, eucalyptus oil, harpin, potassium phosphite, nisin, lactoperoxidase, nerolidol and lactoferrin.

9. Composition as claimed in claim 5, wherein one or more compounds from a first group of plant protection compounds consisting of natamycin, blasticidin-S, kasugamycin, mildiomycin, oxytetracycline, polyoxins (polyoxin B and polyoxorim), streptomycin, and validamycin, are combined with one or more compounds from a second group of plant protection compounds consisting of carvone, carvacrol, CITREX LIQUID, chitosan, thyme oil, azadirachtin, eucalyptus oil, harpin, potassium phosphite, nisin, lactoperoxidase, nerolidol and lactoferrin.

10. Composition as claimed in claim 5, wherein the metals are selected from copper, cobalt, zinc, aluminium, titanium, silver and manganese.

11. Composition as claimed in claim 10, wherein the metals are at least partially complexed with the lignosulfonates.

12. Composition according to claim 11, wherein the lignosulfonates comprise one or more of titanium lignosulfonates, copper lignosulfonates, cobalt lignosulfonates, zinc lignosulfonates, aluminium lignosulfonates, manganese lignosulfonates and silver lignosulfonates.

13. Composition as claimed in claim 5, wherein the acids are organic acids selected from the group consisting of formic acid, acetic acid, propionic acid, citric acid, pelargonic acid, lactic acid, sorbic acid and ascorbic acid.

14. Composition as claimed in claim 5, wherein the acids are inorganic acids selected from the group consisting of hydrochloric acid, phosphoric acid, and sulphuric acid.

15. Composition as claimed in claim 6, wherein the chemical antimicrobial compound is selected from the group consisting of SHIRLAN, MIRAGE Plus, Carbendazim, ALLURE, Euparene, and FOLICUR.

16. Composition as claimed in claim 15, comprising copper-lignosulfonate and SHIRLAN.

17. Composition according to claim 1, wherein the external threat is abiotic stress, and the composition comprises lignosulfonates and one or more compounds that induce stress tolerance.

18. Composition as claimed in claim 17, wherein the one or more compounds that induce stress tolerance are selected from the group consisting of abscisic acid, chitosan, ethylene, salicylic acid, and jasmonic acid.

19. Composition according to claim 1, wherein the external threat is abiotic stress, and the composition comprises lignosulfonates and one or more compounds that stimulate wound repair and growth.

20. Composition as claimed in claim 19, wherein the one or more compounds that stimulate wound repair and growth are selected from the group consisting of cytokinins, gibberellins, brassinosteroids, and auxins.

21. Composition as claimed in claim 1, wherein the lignosulfonates are combined with one or more compounds that induce stress tolerance selected from the group consisting of abscisic acid chitosan, ethylene, salicylic acid, and jasmonic acid, and one or more compounds that stimulate wound repair and growth selected from the group consisting of cytokinins, gibberellins, brassinosteroids, and auxins.

22. Composition according to claim 1, wherein the external threat consists of nematodes and the composition comprises lignosulfonates and one or more cellulose containing materials as the other active ingredient.

23. Composition as claimed in claim 22, wherein the cellulose containing material is selected from the group consisting of cellulose, compost, plant material, and grass fibres.

24. Composition as claimed in claim 22, which composition is a slurry for addition to furrows or plant holes.

25. Composition as claimed in claim 22, which composition is for coating the plant material to be protected.

26. Composition as claimed in claim 22, which composition is for addition to substrates selected from the group consisting of soil, potting soil, vermiculite, coconut fibres, perlite, peat, and rock wool.

27. Composition as claimed in claim 1, which is for improving the quality of crop products, and which comprises lignosulfonates, and a terpene.

28. Composition as claimed in claim 27, wherein the terpene is selected from the group consisting of di-1-p-menthene, carvacrol, and essential oils.

29. Composition as claimed in claim 27, wherein the chelator is selected from the group consisting of EDTA, EDDHA, and citrate.

30. Composition as claimed in claim 1, wherein the external threat is weed and the composition comprises lignosulfonates and small particles of organic material as the other ingredient.

31. Composition as claimed in claim 30, wherein the organic material is heat-treated prior to or after combining it with the one or more poly-phenols.

32. Composition as claimed in claim 30, wherein the organic material is selected from the group consisting of saw dust, and finely ground plant material.

33. Composition according to claim 30, wherein the ratio between lignosulfonates and organic material is between 1:5 and 5:1 by weight.

34. Composition according to claim 1, further comprising one or more compounds selected from the group consisting of trace elements, plant nutrients and anti-microbiological agents.

35. Composition according to claim 1, further comprising one or more compounds selected from the group consisting of detergents, buffers, chelators, spreading agents, adjuvants, preservatives, and boric acid.

36. Composition as claimed in claim 1, wherein the composition is a liquid.

37. Composition as claimed in claim 1, wherein the composition is in a solid form.

38. Composition according to claim 3, wherein at least part of the lignosulfonates comprise one or both of ammonium lignosulfonates and potassium lignosulfonates.

39. Method for controlling weed growth which method comprises applying a composition according to claim 1 to a substrate for crop plants.

40. Method according to claim 39, wherein the composition is applied, calculated by dry weight of the composition, in an amount of 200-4000 kg/ha.

41. Method for protecting plants or plant parts against abiotic stress which method comprises applying a composition according to claim 17 to plants or plant parts.

42. Method for protecting plants or plant parts against biotic stress which method comprises applying a composition according to claim 5 to plants or plant parts.

43. Method for protecting plants or plant parts against nematodes which method comprises applying a composition according to claim 21 to plants or plant parts.

44. Method for improving the quality of crop products which method comprises applying a composition according to claim 27 to the products while growing.

45. Method as claimed in claim 44, wherein the product consists of apple fruits.

46-49. (canceled)

50. Plants or plant parts treated with a composition according to claim 1.

51. Composition as claimed in claim 5, wherein said microorganisms are fungi.

52. Composition as claimed in claim 17, wherein said abiotic stress is selected from the group consisting of drought, salt, heat, cold, and nutrient deficiency.

53. Composition as claimed in claim 19, wherein said abiotic stress is selected from the group consisting of drought, salt, heat, cold, and nutrient deficiency.

54. Composition as claimed in claim 27, further comprising a chelator.

55. Composition according to claim 30, wherein the ratio between lignosulfonates and organic material is between 1:2 and 2:1 by weight.

56. Composition according to claim 30, wherein the ratio between lignosulfonates and organic material is 1:1 by weight.

57. Method according to claim 39, wherein the composition is applied, calculated by dry weight of the composition, in an amount of 400-1200 kg/ha.

58. Method according to claim 39, wherein the composition is applied, calculated by dry weight of the composition, in an amount of 900-1100 kg/ha.

59. Method for protecting plants or plant parts against abiotic stress which method comprises applying a composition according to claim 19 to plants or plant parts.
